(19) United States
(12) Patent Application Publication
(10) Pub. No.: US 2026/0070844 A1
(43) Pub. Date: Mar. 12, 2026

(54) CURABLE GEOPOLYMER SLURRY AND TREATEMENT COMPOSITIONS AND METHODS FOR PRODUCING AND USING SAID COMPOSITIONS

(71) Applicant: SCHLUMBERGER TECHNOLOGY CORPORATION, Sugar Land, TX (US)

(72) Inventors: Andrey Vladimirovich YAKOVLEV, Sugar Land, TX (US); Carlos ABAD, Houston, TX (US)

(21) Appl. No.: 19/100,701

(22) PCT Filed: Aug. 3, 2023
(86) PCT No.: PCT/US2023/071585

§ 371 Date: Feb. 3, 2025

Related U.S. Application Data
(60) Provisional application No. 63/370,296, filed on Aug. 3, 2022.

(51) Int. Cl. C04B 28/00; C04B 22/00; C04B 22/10; C04B 41/45; C04B 41/50; C04B 41/68; C04B 103/10; C04B 111/72

(52) U.S. Cl. CPC C04B 28/006; C04B 22/0006; C04B 22/10; C04B 41/4556; C04B 41/5077; C04B 41/68; C04B 2103/10; C04B 2111/72

(57) ABSTRACT

Geopolymer slurry compositions and methods are described herein that can be used for repair operations in previously cemented wells. The compositions and methods comprise geopolymer slurry compositions having a first component comprising an aqueous-based fluid; a second component comprising an aluminosilicate material; and a third component that activates a polymerization reaction in the slurry composition upon contact with a set cementitious material. The third component can include a set cementitious material.

### CROSS REFERENCE PARAGRAPH

This application claims the benefit of U.S. Provisional Application No. 63/370,296, entitled “CURABLE GEOPOLYMER SLURRY AND TREATMENT COMPOSITIONS AND METHODS FOR PRODUCING AND USING SAID COMPOSITIONS,” filed Aug. 3, 2022, the disclosure of which is hereby incorporated herein by reference.

### FIELD

The present disclosure is generally directed to curable geopolymer slurry and treatment compositions, methods for producing said compositions, and/or methods for using said compositions during or for one or more operations.

### BACKGROUND

Often one or more defects can form or are produced in cemented wells due to insufficient cement placement, insufficient or excessive cement shrinkage, and due to exposure to pressure and/or temperature cycles. Such processes often induce cracks or leaks in cement sheaths of the cemented wells. It is known that wells having the one or more defects often experience sustained casing pressure and reduced flows of hydrocarbons or water upward to the surface. Such wells and/or defects are typically treated with microcement slurries to repair the wells, defects, microannulus, cracks, and/or leaks formed therein. Microcement slurry requires careful design to provide sufficient time for mixing and pumping the slurry before the slurry reacts and becomes unpumpable. Cementitious materials are needed that can be used for such purposes without timing constraints.

### SUMMARY

Embodiments described herein provide a geopolymer slurry composition comprising a first component comprising an aqueous-based fluid; a second component comprising at least one aluminosilicate material; and a third component that activates a polymerization reaction in the slurry composition upon contact with a set cementitious material.

Other embodiments described herein provide a geopolymer slurry composition, comprising a first component comprising an aqueous-based fluid; a second component comprising an aluminosilicate material; and a third component that comprises a set cementitious material.

Other embodiments described herein provide a method, comprising introducing a geopolymer slurry composition into a previously set cementitious material; activating a polymerization reaction within the geopolymer slurry composition; and forming a geopolymer in contact with the previously set cementitious material that repairs defects in the previously set cementitious material.

Other embodiments described herein provide a method, comprising introducing a geopolymer slurry composition into a previously set cementitious material, the geopolymer slurry composition comprising a first component comprising an aqueous-based fluid; a second component comprising an aluminosilicate material; and a third component that comprises a set cementitious material; activating a polymerization reaction within the geopolymer slurry composition; and forming a geopolymer in contact with the previously set cementitious material.

### DETAILED DESCRIPTION

Geopolymer slurry treatment compositions are described herein that only react, set, or cure upon contact with a hydrated cementitious material, and so do not require any optimization of thickening time. The geopolymer slurry and treatment compositions described herein may be pumpable into a well previously treated with a cementitious material, such as a cement or geopolymer, to repair defects, microannulus voids, fractures, cracks, and/or leaks in the cementitious material. In some cases, the geopolymer slurries described herein use alkali metal salts in suitable concentrations to enhance in situ activation of the slurries within the well while avoiding premature hardening of the slurry before the slurry can be placed downhole. This approach removes the field constraint of needing to pump the slurry downhole before it hardens because activation of the slurry is substantially delayed until the slurry is placed in the well. The slurry treatment compositions described herein can also be used for repair in other contexts, such as subterranean or surface flow pathways or construction applications.

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

The slurry treatment compositions described herein are geopolymer slurry compositions. Such slurry compositions can support a polymerization reaction in the presence of high pH to form geopolymers. Geopolymers are materials that are formed by chemical dissolution and subsequent recondensation of various aluminosilicate oxides and silicates to form an amorphous three-dimensional framework structure. Therefore, a geopolymer is a three-dimensional aluminosilicate mineral polymer. Geopolymers based on alumino-silicates are designated as poly(sialate), which is an abbreviation for poly(silicon-oxo-aluminate) or (—Si—O—Al—O—)ₙ (with n being the degree of polymerization). The sialate network comprises SiO₄ and AlO₄ tetrahedra linked alternately by sharing all the oxygens, with Al³⁺ and Si⁴⁺ in IV-fold coordination with oxygen. Positive ions (Na⁺, K⁺, Li⁺, Ca²⁺ . . . ) may be present in the framework cavities to balance the negative charge of Al³⁺ in IV-fold coordination.

The empirical formula of polysialates is: Mₙ{—(SiO₂)_{z}—AlO₂}ₙ, w H₂O, wherein M is a cation such as potassium, sodium or calcium, n is a degree of polymerization and z is the Si/Al atomic ratio that may be 1, 2, 3 or more.

The three-dimensional (3D) geopolymers networks are summarized in Table 1.

TABLE 1
Geopolymer chemical designations (wherein M is a cation such
as K, Na or Ca, and n is a degree of polymerization).

| Si/Al | | | |
|---|---|---|---|
| ratio | Designation | Structure | Abbreviations |
| 1 | Poly(sialate) | Mₙ(—Si—O—Al—O—)ₙ | (M)-PS |
| 2 | Poly(sialate-siloxo) | Mₙ(—Si—O—Al—O—Si—O)ₙ | (M)-PSS |
| 3 | Poly(sialate-disiloxo) | Mₙ(—Si—O—Al—O—Si—O—Si—O—)ₙ | (M)-PSDS |

The properties and application fields of geopolymers depend principally on their chemical structure, and more particularly on the Si/Al molar ratio. Geopolymers have been investigated for use in several applications, including as concrete systems within the construction industry, as refractory materials and as encapsulants for hazardous and radioactive waste streams. Geopolymers are also recognized as being rapid setting and hardening materials. They exhibit superior hardness and chemical stability. As noted above, in many cases the geopolymer precursor described herein as slurry treatment compositions can be pumped. A geopolymer precursor is generally considered pumpable where slurry consistency is lower than about 70 Bc (Bearden consistency units) as measured by a high-temperature, high-pressure consistometer. In some cases, the yield value (Ty) for a pumpable slurry may be lower than about 60 lbf/100 ft2

Described herein are geopolymer slurry and treatment compositions (hereinafter “the slurry treatment composition”), methods for producing the slurry treatment composition (hereinafter “the production method”), and methods for using the slurry treatment composition during or for treatment of a previously placed cementitious material (hereinafter “the treatment method”). The slurry treatment compositions herein are, generally, aqueous slurries of aluminosilicate materials that contain a component that can be an alkali metal salt, or mixture of alkali metal salts, and/or a previously set cementitious material. The production method generally includes combining and/or mixing components of the slurry treatment composition. The treatment method generally includes pumping or introducing the slurry treatment composition to a target location, for example into a well, that contains a previously placed cementitious material having a defect in need of repair.

The slurry treatment composition, when activated, can react (cure, set, harden) to form a geopolymer (hereinafter “the geopolymer”), which is a solid material that may be less permeable than materials surrounding the geopolymer. The geopolymer may be a slag-based geopolymer, a rock-based geopolymer, a fly ash-based geopolymer, a metakaolin-based geopolymer, a ferro-sialate-based geopolymer, or a geopolymer based on a combination of such components.

In some embodiments, the slurry treatment composition may be utilized in or for one or more well treatments. For example, the slurry treatment composition may be disposed within, pumped, or otherwise introduced into a well having a previously placed cementitious material to repair defects therein, such as voids, fractures, cracks, wall leaks, microannuli, or a combination thereof. The slurry treatment composition is introduced to the well in a flowable state, and is believed to flow into spaces defined by the defects and at least partially fill the spaces. After being disposed within the well, it is believed that, upon placement with the previously placed cementitious material, in some cases upon contact with the previously placed cementitious material, a polymerization reaction is activated to begin forming a geopolymer within the spaces defined by the defects. As a result of the reacting, the slurry treatment composition sets, cures, or hardens to form the geopolymer, which is believed to repair the defects in the previously placed cementitious material. In one case, the slurry treatment compositions described herein can be used in a so-called “squeeze cementing” operation to repair a cementitious material previously placed within a well.

The slurry treatment composition comprises a plurality of slurry treatment composition components (hereinafter “the composition components”) for forming or producing the geopolymer, at least one first composition component (hereinafter “the first component”), at least one second composition component (hereinafter “the second component”), and at least one third composition component (hereinafter “the third component”). The composition components may also comprise at least one additive component (hereinafter “the additive component”).

The first component is an aqueous-based component, which may be water or a water-based fluid. The first component is generally present in the slurry treatment composition at a concentration in the range of about 10% by weight to about 70% by weight, about 15% by weight to about 60% by weight, about 20% by weight to about 50% by weight, about 25% by weight to about 45% by weight, or about 30% by weight to about 40% by weight based on a total weight of the slurry treatment composition.

The second component is, or includes, an aluminosilicate material. Examples of aluminosilicate materials that may be used include granulated blast furnace slag (e.g. ground granulated blast furnace slag “GGBS”), a fly ash such as ASTM type C or F fly ash or an unclassified fly ash, volcanic ash, calcined or partially calcined clays (such as metakaolin), aluminum-containing silica fume, natural aluminosilicate, synthetic aluminosilicate glass powder, zeolite, scoria, allophone, bentonite, red mud, which may be calcined or partially calcined, pumice, and combinations thereof. Alumina sources and silica sources can also be mixed to form a synthetic aluminosilicate material. For example, a mixture of bauxite and silica fume can be used. The second component is a particulate material having a particle size in a range of 100 microns or less, such as 20 microns or less, 5 microns or less, about 0.1 microns to about 100 microns, about 0.3 microns to about 30 microns, or about 1 micron to about 10 microns.

The third component is generally a material that activates a polymerization reaction in the slurry treatment composition or combines with another material to activate the polymerization reaction. In one case, the third component is, or includes, a material that activates a polymerization reaction in the slurry treatment composition upon contact with a set cementitious material, which can be a previously placed and set cementitious material that needs repair. Such a material can be an alkali metal salt. The third component may be selected from the group consisting of a sodium salt, a potassium salt, a lithium salt, a rubidium salt, a cesium salt, and a combination thereof. That is, the alkali metal of the alkali metal salt can be selected from the group consisting of sodium, potassium, lithium, rubidium, cesium, and a combination thereof. The third component may be a salt selected from the group consisting of a carbonate, a bicarbonate, a sulphate, a bisulphate, a phosphate, a phosphonate, an oxalate, a silicate, a fluoride, a fluorosilicate, an iodate, a molybdate, and a combination thereof. Sodium carbonate is an example of a suitable alkali metal salt. In another case, the third component can be a set cementitious material. In such a case, the previously set and hardened cementitious material is rendered to a form that can be used as a component of a slurry treatment composition. For example, a set cementitious material that is rendered into a particulate form, for example a powder form, can be used. In another example, the third component can be a mixture of one or more alkali metal salts and a previously set cementitious material, rendered to a form that can be used as a component of a slurry treatment composition.

The third component, or the alkali metal salt of the third component, may be present in the slurry treatment composition at a concentration in the range of about 0.1 to about 30% by weight, about 0.5 to about 20% by weight, or preferably about 1 to about 10% by weight based on the total weight of the slurry treatment composition. The third component, or the alkali metal salt of the third component, may be a particulate material having a particle size in a range of 100 microns or less, such as 20 microns or less, 5 microns or less, about 0.1 microns to about 100 microns, about 0.3 microns to about 30 microns, or about 1 micron to about 10 microns. The third component may be encapsulated in a material that degrades, dissolves, or decomposes under conditions experienced at the target location. The second and third components may be encapsulated together in some cases. Encapsulating components of the slurry treatment composition delays contact with water and pre-placed cementitious material to allow full placement and penetration of the slurry treatment composition before polymerization begins.

The slurry treatment composition may comprise a density modifier component. The optional density modifier component can be selected from the group consisting of hollow glass or ceramic microspheres (cenospheres), plastic particles, uintaite, vitrified shale, petroleum coke or coal, hematite, barite, ilmenite, silica, manganese tetroxide, and a combination thereof. In one or more embodiments, the density modifier component may be present in the slurry treatment composition at a concentration of 10 to 90% by weight, or 20 to 70% by weight or preferably 30 to 50% by weight based on the total weight of the slurry treatment composition.

The optional additive component may be and/or may comprise a retarder, accelerant, antifoam agent, defoamer, fluid-loss control additive, viscosifier, dispersant, expanding agent, anti-settling additive, or a combination thereof. More than one of each such material may be used. The additive component may be present in the slurry treatment composition at a range of about 0.005 to about 5% by weight, of about 0.01 to about 1%, or preferably of about 0.05 to about 0.5% by weight.

Formation of a geopolymer involves an activator. the slurry treatment compositions described herein can be activator free, only activating upon contact with a pre-placed cementitious material that contains an activator Alternately, the slurry treatment composition may contain a previously set cementitious material. The activator may be a hydroxide material, such as hydroxide, which may be in the previously set cementitious material.

The slurry treatment compositions herein may include an activator, such as an alkali metal hydroxide or alkaline earth metal hydroxide material, but in general any activator present in the slurry treatment composition will be insufficient to harden the slurry treatment composition. For example, a hydroxide material can be added to the slurry treatment composition prior to introducing the slurry treatment composition to a target location, but a concentration of the hydroxide material, as added to the slurry treatment composition, is insufficient to increase pH beyond about 12.5 to avoid reacting the aluminosilicate materials in the slurry treatment composition prior to contact with a pre-placed cementitious material. Including a low level of an activator can be helpful in some cases where the pre-placed cementitious material has a low level of activating components, activators or activator precursors, such that the combination of the activating components of the pre-placed cement and the added hydroxide material, together, activate the slurry treatment composition to form a geopolymer.

The slurry treatment composition is formed by combining, mixing, blending, and/or adding the components together. The slurry treatment composition can be used for any type of cementitious material repair, which may be in a subterranean well or other subterranean conduit or flow path, or may be at a surface location such as a construction site. The slurry treatment composition is injected, introduced, or placed at a target location where a previously placed cementitious material has become defective. The slurry treatment composition is disposed in contact with the previously placed cementitious material to at least partially fill a microannulus void, fracture, crack, or leak pathway in the previously placed cementitious material. Upon contact with the previously placed cementitious material, the slurry treatment composition reacts to form geopolymer that repairs the defects.

The methods disclosed herein may include disposing the slurry treatment composition at a target location in a subterranean flow path, contacting the slurry treatment composition with a previously placed cementitious material in the subterranean flow path, and reacting the slurry treatment composition with a component of the previously placed cementitious material within the subterranean flow path to form a geopolymer. The methods disclosed herein may include adding the slurry treatment composition to a wellbore fluid and introducing the mixture of the wellbore fluid and the slurry treatment composition into a subterranean well at a location where a previously placed cementitious material has a defect to repair the defect. In another embodiment, the methods disclosed herein may comprise placing the slurry treatment composition into a cemented well, which may be done during a well operation.

The slurry treatment composition may be introduced into the cemented well such that the slurry treatment composition contacts a set cement within the cemented well. It is generally believed that the slurry treatment composition reacts with the set cement, or at least one or more components of the set cement, resulting in formation of a geopolymer.

It is generally believed that an alkali metal salt dissolved in a slurry treatment composition can react with hydroxide materials such as portlandite present in a set cement or geopolymer previously placed in a well to form an activator in situ, increasing pH of the slurry. Aluminosilicate present in the slurry treatment composition is activated by the elevated pH to begin a polycondensation reaction that forms a geopolymer for repairing a defect in the previously placed cement or geopolymer. Generation of the activator in situ reduces exposure to corrosive materials at the surface, since the activator is only generated in situ. In situ activation of a slurry treatment composition also removes any timing constraints on placing the slurry treatment composition since the composition is not activated, and cannot set or cure, before contact is made with the previously placed cement or geopolymer. The alkali metal salt may fully dissolve in the slurry treatment composition before placement at a target location, or the alkali metal salt may partially dissolve before placement and fully dissolve after encountering native fluids or other materials at the target location.

In an embodiment, the aluminosilicate material may be selected from the group of a slag, a granulated blast furnace slag, a fly ash, volcanic ash, calcined clay, aluminum-containing silica fume, natural aluminosilicate, synthetic aluminosilicate glass powder, zeolite, scoria, allophone, bentonite, red mud, pumice, or a combination thereof with particle size preferably below about 20 microns. Alkali metal salts for the repair slurry can be selected from the group consisting of a carbonate, a bicarbonate, a sulphate, a bisulphate, a phosphate, a phosphonate, an oxalate, a silicate, a fluoride, a fluorosilicate, an iodate, a molybdate, and a combination thereof. The alkali metal of the alkali metal salt can be sodium, potassium, lithium, rubidium, cesium, or a combination thereof.

### EXAMPLE

### GGBS (Slag) Geopolymer Slurries

Table 1 shows the result of mixing two aqueous slurries, A1 and A2, prepared in a laboratory setting according to API procedure RP 10B-2. Composition of the two slurries, shown in Table 1, are substantially identical, each containing GGBS as an aluminosilicate source and no activator. Slurry A2 is different from slurry A1 by inclusion of portlandite, which is a hydroxide material commonly found in set cements. Slurry A1 has zero compressive strength after 24 hours, but slurry A2 has 1,250 psi compressive strength after 24 hours. Inclusion of portlandite in slurry A2 activates a polymerization reaction that forms a geopolymer. Based on the performance of slurry A2, it is believed that Slurry A1 would set when it gets into a contact with a previously set cement containing a hydroxide material. Portlandite, or other hydroxide material, in the set cement is believed to increase pH of a slurry such as the slurry A1 to a level that can activate a polymerization reaction, for example from 11.5 to 13.5. As a result, slurry A1 will become like slurry A2 and will set, cure, or harden to form a geopolymer.

TABLE 2
A1, A2 formulations

| Sample | A1 | A2 |
|---|---|---|
| GGBS, g | 188 | 188 |
| Silica sand, g | 466 | 466 |
| Soda ash, g | 38 | 38 |
| Portlandite, g | — | 25 |
| PEG anti-foam, g | 1 | 1 |
| Water, g | 358 | 334 |

TABLE 3
Performance of A1-A2 slurries at BHCT = 60 deg C

| Sample | A1 | A2 |
|---|---|---|
| PV/Ty (after mixing) | 33/8 | N/M |
| PV/Ty (after conditioning) | 28/12 | N/M |
| Thickening time, 70 Bc (hh:mm) | >24 h | 0:32 |
| Compressive strength after 24 hrs, psi | 0 | 1250 |

N/M—not measured

### Fly Ash Geopolymer Slurries

Table 4 shows the result of curing four aqueous slurries, B1-B4, prepared in a laboratory setting according to API procedure RP 10B-2. Compositions of the slurries are shown in Table 3, each containing fly ash type C as an aluminosilicate source. Slurry B1 has no activator, slurry B2 contains ground set cement, B3-sodium carbonate, B4-ground set cement and sodium carbonate as activators. Only slurry B1 didn't set after 48 hours. Among slurries B2-B4, B4 showed the fastest and the highest level of compressive strength.

TABLE 3
B1-B4 formulations

| Sample | B1 | B2 | B3 | B4 |
|---|---|---|---|---|
| Fly ash type C, g | 597 | 555 | 536 | 496 |
| Ground set cement | | 60 | | 60 |
| (14.8 lb/gal | | | | |
| class C), g | | | | |
| Soda ash, g | | | 40 | 40 |
| PEG anti-foam, g | 1 | 1 | 1 | 1 |
| Water, g | 380 | 360 | 401 | 382 |

TABLE 4
Performance of B1-B4 slurries at BHCT = 55 deg C.

| Sample | B1 | B2 | B3 | B4 |
|---|---|---|---|---|
| Compressive | 0 | 0 | 0 | 240 psi |
| strength after | (didn't | (didn't | (didn't | |
| 24 hrs, psi | set) | set) | set) | |
| Compressive | 0 | 80 psi | 170 psi | 390 psi |
| strength after | (didn't | | | |
| 48 hrs, psi | set) | | | |

The slurry treatment compositions herein may include, as an additive, a metal silicate. The metal silicate may be an alkali metal silicate such as sodium silicate, sodium metasilicate or potassium silicate. Silicates of Li, Na, K, Rb, and Cs or their combination can be used. The metal silicate, such as sodium metasilicate, may be present at a concentration between 0.01 kg/L and 0.2 kg/L, or between 0.05 kg/L and 0.1 kg/L. The SiO2/Na2O molar ratio may be less than or equal to 3.2. The SiO2/K2O molar ratio may be less than or equal to or less than 3.2. The metal silicate may be present in the composition at a concentration between about 0.1M and 5M, or between 0.5M and 2M. The metal silicates may be dry blended with the aluminosilicate source. Also, the metal silicate in another embodiment may be encapsulated.

The slurry treatment compositions herein may include, as an additive component, retarders and accelerators. Several retarders may delay the setting and hardening of the slurry treatment compositions herein. Retarders such as sodium pentaborate decahydrate, borax, boric acid, lignosulphonates, sodium glucoheptonate tartaric acid, citric acid, or phosphorus containing compounds such as phosphoric acid, salts thereof, or mixtures thereof can be included in the geopolymer slurry in amounts up to about 1 part per hundred by weight of the total geopolymer slurry. The amount of retardation of the polymerization reaction, and the setting of the slurry, depends on the type of raw materials used for the slurry and the type and relative quantity of retarding reagent used. Adding too much retarder reagent to a geopolymer slurry can cause the slurry to remain unhardened by interfering with the polymerization reaction so the geopolymer slurry does not set. Accelerators can include lithium salts.

The slurry treatment compositions herein generally have a slurry density range from 0.84 g/cm3 [7 lbm/gal] to 2.87 g/cm3 [24 lbm/gal]. The slurry density can be influenced by quantity of water added and/or by adding any of the density modifiers described above. Density modifiers can include density increasing particles and density lowering particles. Low-density particles may be included in the geopolymer slurry to achieve lower slurry densities for a given amount of water added, or heavy particles may be added to achieve higher slurry densities. The lightweight particles may have densities lower than 2 g/cm³, or lower than 1.3 g/cm³. Examples include hollow glass or ceramic microspheres (cenospheres), plastic particles such as polypropylene beads, rubber particles, uintaite (sold as GILSONITE™), vitrified shale, petroleum coke or coal or combinations thereof. The lightweight particles may be present in the geopolymer slurry at concentrations between about 0.06 kg/L and 0.6 kg/L (20 lb/bbl and 200 lb/bbl). The particle size range of the low-density particles may be between about 38 μm and 3350 μm (6 mesh and 400 mesh). The heavy particles typically may have densities exceeding 2 g/cm³, or more than 3 g/cm³. Examples include hematite, barite, ilmenite, silica (e.g. crystalline silica sand), crushed granite and also manganese tetroxide commercially available under the trade names of MicroMax™ and MicroMax FF™.

Other additive components, such as antifoam agents, defoamers, silica, fluid-loss control additives, viscosifiers, dispersants, expanding agents, anti-settling additives or combinations thereof. Selection of the type and amount of additive largely depends on the desired nature and properties of the geopolymer, and those of ordinary skill in the art will understand how to select a suitable type and amount of additive for compositions herein.

The fluid-loss control agent may include a latex material. The latex may be an alkali-swellable latex. The latex may be present in the geopolymer slurry at a concentration between 0.02 L/L and 0.3 L/L (1 gal/bbl and 15 gal/bbl), or between 0.05 L/L and 0.15 L/L.

Viscosifiers may comprise a polysaccharide. Diutan gum having a molecular weight higher than about 1×10⁶ can be used. The diutan gum may be present in the geopolymer slurry at a concentration between 0.14 g/L and 1.4 g/L (0.05 lbm/bbl and 0.5 lbm/bbl). Other viscosifiers may comprise polysaccharide biopolymers such as welan gum, a polyanionic cellulose (PAC), a carboxymethylcellulose (CMC), or a combination thereof present at a concentration between 0.14 g/L and 1.4 g/L (0.05 lbm/bbl and 0.5 lbm/bbl). The molecular weight of the polysaccharides, which may be biopolymers, may be between 100,000 and 1.000,000.

Carboxylic acids including gluconic acid, glucoheptanoic acid, tartaric acid, citric acid, glycolic acid, lactic acid, formic acid, acetic acid, proprionic acid, oxalic acid, malonic acid, maleic acid, succinic acid, adipic acid, malic acid, nicotinic acid, benzoic acid and ethylenediamine tetraacetic acid (EDTA), may be included in the geopolymer slurry as retarders or disperants or both. Phosophoric acids may be present for the same purpose. Soluble salts of these acids may also be employed. The acids and salts can be used in any combination, and may be present in the geopolymer slurry at total concentrations between 0.5 g/L and 10 g/L, or between 1 g/L and 5 g/L.

Expanding agents may comprise calcium sulfate hemihydrate, metal oxides such as MgO or combinations thereof. The expanding agents may be present in the geopolymer prr at concentrations between 0.01 kg/L and 0.2 kg/L of slurry, or between 0.05 and 0.1 kg/L.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

1-46. (canceled)

47. A geopolymer slurry composition comprising:
a first component comprising an aqueous-based fluid;
a second component comprising an aluminosilicate material; and
a third component that activates a polymerization reaction in the slurry composition upon contact with a set cementitious material.

48. The geopolymer slurry composition of claim 47, wherein the third component comprises an alkali metal salt.

49. The geopolymer slurry composition of claim 48, wherein the alkali metal of the alkali metal salt is selected from the group consisting of sodium, potassium, lithium, rubidium, cesium, and a combination thereof.

50. The geopolymer slurry composition of claim 48, wherein the alkali metal salt is selected from the group consisting of a carbonate, a bicarbonate, a sulphate, a bisulphate, a phosphate, a phosphonate, an oxalate, a silicate, a fluoride, a fluorosilicate, an iodate, a molybdate, and a combination thereof

51. The geopolymer slurry composition of claim 48, wherein the alkali metal salt is present in the slurry composition at a concentration of about 0.1% by weight to about 30% by weight, based on a total weight of the slurry composition.

52. The geopolymer slurry composition of claim 47, wherein the geopolymer slurry composition is free of any activator.

53. The geopolymer slurry composition of claim 47, wherein the second component has a particle size less than about 100 microns.

54. The geopolymer slurry composition of claim 47, wherein the aluminosilicate material is selected from the group consisting of a slag, a fly ash, a volcanic ash, a clay, an aluminum-containing silica fume, a natural aluminosilicate, a synthetic aluminosilicate, a zeolite, a scoria, an allophone, a bentonite, a red mud, a pumice, and a combination thereof.

55. A geopolymer slurry composition, comprising:
a first component comprising an aqueous-based fluid;
a second component comprising an aluminosilicate material; and
a third component that comprises a set cementitious material.

56. The geopolymer slurry composition of claim 55, wherein the second component has a particle size less than about 20 microns.

57. The geopolymer slurry composition of claim 55, wherein the aluminosilicate material is selected from the group consisting of a slag, a fly ash, a volcanic ash, a clay, an aluminum-containing silica fume, a natural aluminosilicate, a synthetic aluminosilicate, a zeolite, a scoria, an allophone, a bentonite, a red mud, a pumice, and a combination thereof.

58. A method, comprising:
introducing a geopolymer slurry composition into a previously set cementitious material;
activating a polymerization reaction within the geopolymer slurry composition; and
forming a geopolymer in contact with the previously set cementitious material that repairs defects in the previously set cementitious material.

59. The method of claim 58, wherein the geopolymer slurry composition comprises:
a first component comprising an aqueous-based fluid;
a second component comprising an aluminosilicate material; and
a third component that activates a polymerization reaction in the slurry composition upon contact with a set cementitious material.

60. The geopolymer slurry composition of claim 59, wherein the third component comprises an alkali metal salt.

61. The geopolymer slurry composition of claim 60, wherein the alkali metal of the alkali metal salt is selected from the group consisting of sodium, potassium, lithium, rubidium, cesium, and a combination thereof.

62. The geopolymer slurry composition of claim 60, wherein the alkali metal salt is selected from the group consisting of a carbonate, a bicarbonate, a sulphate, a bisulphate, a phosphate, a phosphonate, an oxalate, a silicate, a fluoride, a fluorosilicate, an iodate, a molybdate, and a combination thereof.

63. The geopolymer slurry composition of claim 60, wherein the alkali metal salt is present in the slurry composition at a concentration of about 0.1% by weight to about 30% by weight, based on a total weight of the slurry composition.

64. The geopolymer slurry composition of claim 59, wherein the second component has a particle size less than about 5 microns.

65. The geopolymer slurry composition of claim 59, wherein the aluminosilicate material is selected from the group consisting of a slag, a fly ash, a volcanic ash, a clay, an aluminum-containing silica fume, a natural aluminosilicate, a synthetic aluminosilicate, a zeolite, a scoria, an allophone, a bentonite, a red mud, a pumice, and a combination thereof.

66. The method of claim 59, wherein the third component comprises a set cementitious material.
